(19) United States
(12) Patent Application Publication
(10) Pub. No.: US 2020/0369883 A1
(43) Pub. Date: Nov. 26, 2020

(54) A Thermoplastic Polyamide Composition and A Manufacturing Method and An Application Thereof

(71) Applicant: BASF SE, Ludwigshafen am Rhein (DE)

(72) Inventors: Lin Chen, Shanghai (CN); Zhenguo Liu, Flanders, NJ (US)

(21) Appl. No.: 16/767,627

(22) PCT Filed: Nov. 21, 2018
(86) PCT No.: PCT/EP2018/082009

§ 371 Date: May 28, 2020

(30) Foreign Application Priority Data
Nov. 28, 2017 (CN) PCT/CN2017/113318

(51) Int. Cl. C08L 77/02; C08L 77/06; C08L 71/12; C08L 51/08; C08K 7/14

(52) U.S. Cl. CPC C08L 77/02; C08L 77/06; C08L 2203/20; C08L 51/08; C08K 7/14; C08L 71/126

(57) ABSTRACT

Described herein is a thermoplastic polyamide composition comprising long chain polyamide of 25-65 wt %, modified poly (arylene ether) resin of 5-20 wt %, and D-glass fibers of 30-65 wt %. Also described herein is a manufacturing process of the thermoplastic polyamide composition and a method of using the thermoplastic polyamide composition in high frequency communication products. The thermoplastic polyamide composition expresses very good dielectric property and good mechanical properties useful in high frequency communication technology.

### FIELD OF THE INVENTION

The present invention relates to the thermoplastic resin composition, especially relates to the thermoplastic polyamide composition and a manufacturing process and an application thereof.

### DESCRIPTION OF RELATED ART

With the development of high frequency communication technology, traditional ceramic insulation material gradually can't meet the demand in electronic industry such as antenna housing, mobile device and integrated circuit. Meanwhile thermoplastic gradually show its benefit of design flexibility and excellent performance. Thermoplastic polyamide is one of the most strong and tough plastic material which makes it quite promising as structural parts of electronic devices. However, the high polarity of polyamide leads to the high dielectric property with D_{K} is ca. 4-5, it's quite challenging to make a polyamide compound, especially glass reinforced compound with desirable low dielectric property.

Dielectric property refers to the extent to which a material concentrates electric flux and the energy loss rate, usually expressed as dielectric constant D_{K} and dissipation factor D_{F}. A high dielectric constant and dissipation factor of polyamide, in and of itself, is not necessarily desirable for high frequency communication industry. As D_{K} and D_{F} increases, the electric flux density and energy loss increases. The accumulation of charge will disturb the signal transmission, reduce the reliability of electric circuit, limit the further increase of frequency. The energy loss will generate heat and influence the use. In another aspect, substances with high dielectric constants break down more easily when subjected to intense electric fields, than do materials with low dielectric constants. Low dielectric constant and low dissipation factor is the desirable property for polyamide compound, and comparing with dissipation factor dielectric constant is more critical parament for high frequency communication industry.

Thus, for applying the thermoplastic polyamide to high frequency communication industry, low dielectric polyamide composition is needed to meet the requirements of electrical properties.

The common way to lower the dielectric property of the polymer composition is to choose the polymer with low dielectric property. Polyphenylene oxide, of which D_{K} is around 2.5 is widely used to decrease the dielectric property of the polymer composition.

WO 2017029564A disclosed a resin composition comprising 40-90 wt % poly (arylene ether), 0-40 wt % high-impact polystyrene (HIPS) and 0-40 wt % general purpose polystyrene, provided that the HIPS, the GPPS, or the combination thereof represents 5-40% by weight of said composition, 5-25 wt % impact modifier and 15-400% ceramic filler. As the low processing property of poly (arylene ether), polystyrene was used to increase the machinability. The composition has the D_{K} of 3-3.3 when the content of polyphenylene oxide (PPO) is higher than 65%, and the ceramic filler is lower than 35 wt %, the weight is based on the total weight of the composition. When the content of PPO is lower than 65 wt % or the ceramic filler is higher than 35 wt %, the D_{K} will increase rapidly even to 9.7 (see table 5 of WO2017029564A). Meanwhile, due to the poor process property of PPO, the process ability of PPO composition will become poorer when the content of PPO is higher. This shows that it's not easy to approach lower D_{K} of the plastic composition even when the D_{K} of each component is low.

CN 103965606A disclosed a polyphenylene oxide (PPO) composition, which comprises PPO of 40-80 weight parts, bismaleimide of 5-30 weight parts and additive of 5-30 weight parts, the D_{K} of the composition is 3.75-4.0, D_{F} is 0.0025-0.0045. Wherein, the PPO is preferably with the chemical structure of Formula I.

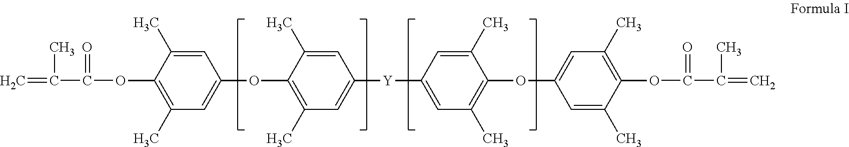

The D_{K} of the composition in CN 103965606A is much higher than the D_{K} of PPO, almost 50% increase. The application of this composition focuses on the high demand of water absorption and thermal expansion coefficient. The bismaleimide is used to decrease the thermal expansion coefficient. However, the mechanical properties could not fulfill the demand for high frequency electronical industry.

A known way to decrease the dielectric property of polyamide composition is to blend polyamide with polypropylene. However, the dielectric and mechanical property is not so ideal to fit the higher demand of high frequency industry.

The resin composition with low dielectric property and good mechanical property is demanding for high frequency communication technology.

### SUMMARY OF THE INVENTION AND ADVANTAGES

Disclosed is a thermoplastic polyamide composition, which could approach low dielectric properties with D_{K} is about 3.2-3.3, compared with the D_{K} of polyamide of 4-5, it decreased a lot. Meanwhile, the mechanical properties of the polyamide composition could also reach the requirement of application in such as high frequency communication field.

### DETAILED DESCRIPTION OF THE INVENTION

The present invention discloses a thermoplastic polyamide composition comprising long chain polyamide of 25-65 wt %, modified poly(arylene ether) resin of 5-20 wt %, and D-glass fibers of 30-65 wt %, wt % is based on the weight of the thermoplastic polyamide composition.

### The Long Chain Polyamide

Based on the reactant or reaction mechanism, the polyamide in the present invention comprises two groups, one is polyamide from lactam, the other one is polyamide from diacid and diamine. For the polyamide from lactam which is prepared by ring opening of lactam, the long chain polyamide in the invention can be the polyamide from lactam which having 8 or more carbon atoms, preferably having from 8 to 14 carbon atoms. The polyamide from lactam preferably is polyamide 8, 9, 10, 11, 12 and/or 13.

For the polyamide from diacid and diamine, which is prepared by reacting dicarboxylic acid with diamine, the long chain polyamide in the invention could be the polyamide from diacid and diamine which having 8 or more carbon atoms for at least one of diacid and diamine. The diacid in the invention is the conventional diacid used to produce polyamide, preferably is alkane dicarboxylic acid of from 6 to 24 carbon atoms, more preferably is of from 6 to 18 carbon atoms, most preferably is of 6, 8, 9, 10, 11, 12, 13, 14, 15, 16, 17 and/or 18 carbon atoms. The diacid in the invention could also be the aromatic diacid, such as terephthalic acid, isophthalic acid, naphthalenedicarboxylic acids and/or diphenyldicarboxylic acids. The diamine in the invention is the conventional diamine used to produce polyamide, preferably is alkane diamine of from 6 to 24 carbon atoms, more preferably is from 6 to 18, most preferably is of 6, 8, 9, 10, 11, 12, 13 and/or 14 carbon atoms. The diamine in the invention could also be the aromatic diamine, such as m-xylylenediamine(MXDA), p-xylylenediamine, bis(4-aminophenyl)methane, 3-methylbenzidine, 2,2-bis(4-aminophenyl)propane, 1,1-bis(4-aminophenyl)cyclohexane, 1,2-diaminobenzene, 1,3-diaminobenzene, 1,4-diaminobenzene, 1,2-diaminonaphthalene, 1,3-diaminonaphthalene, 1,4-diaminonaphthalene, 2,3-diaminotoluene, N,N′-dimethyl-4,4′-bephenyldiamine, bis(4-methylaminophenyl)methane, and/or 2,2′-bis(4-methylaminophenyul)propane.

The long chain polyamide could preferably be at least one selected from the group consisting of PA8, PA9, PA10, PA11, PA12, PA13, PA4.8, PA4.10, PA4.12, PA4.14, PA4.18, PA5.8, PA5.10, PA5.12, PA5.14, PA5.18, PA6.8, PA6.10, PA6.12, PA6.14, PA6.18, PA8.8, PA8.10, PA8.12, PA10.10, PA10.12, PA10.14, PA10.18, PA12.10, PA12.12, PA12.14, PA12.18, PA14.10, PA14.12, PA 14.14, PA14.18, PA8.T, PA9.T, PA10.T, PA12.T, PA8.I, PA9.I, PA10.1, and PA12.I, more preferably is PA1010, PA10.12, PA12.10 and/or PA12.12

The long chain polyamide could be the homo-polymer of the long chain polyamide, blends of at least two long chain polyamides and/or long chain polyamide copolymerized co-polyamide.

The long chain polyamide copolymerized co-polyamide is the polyamide copolymer in which the building segments of the polyamide copolymer comprising at least one long chain polyamide segment (segment A), the rest segment(s) of the polyamide copolymer could be non-long chain polyamide segments or the other long chain segment(s) except segment A, the examples of the rest segments could be PA 6, PA 6.6 and/or PA X.T, X is from 4 to 24, preferably the rest segment is PA6, PA 6.6, PA 4.T, PA6.T, PA8.T, PA 9.T, PA10.T, PA12.T and/or PA14.T.

There is no limitation of the type of the copolymer, for example block copolymer, random copolymer, graft copolymer or alternating copolymer.

The long chain polyamide in the invention could have the conventional molecule weight in polyamide composition, the relative viscosity of the long chain polyamide is preferable 1.8-4.0 measured in sulfuric acid solution of 98 wt % at 25° C.

The long chain polyamide in the thermoplastic polyamide composition is preferably in the amount of 30-60 wt %, more preferably is of 35-55 wt %, most preferably is of 40-50 wt %, wt % is based on the total weight of the thermoplastic polyamide composition.

The Modified poly(arylene ether) Resin

The modified poly(arylene ether) resin is the poly (arylene ether) which is modified by other components, preferably is modified by α, β-unsaturated dicarboxylic acid and/or by anhydride of α, β-unsaturated dicarboxylic acid.

The α, β-unsaturated dicarboxylic acid could be chosen from the conventional α, β-unsaturated dicarboxylic acid, preferably is at least one selected from the group consisting of maleic acid, fumaric acid, itaconic acid, tetrahydrophthalic acid, and citraconic acid, more preferably is maleic acid. The anhydride of α, β-unsaturated dicarboxylic acid could be chosen from the conventional anhydride of α, β-unsaturated dicarboxylic acid, preferably is at least one selected from the group consisting of maleic anhydride, itaconic anhydride, gluconic anhydride, citraconic anhydride and tetrahydrophthalic anhydride, more preferably is maleic anhydride.

The poly(arylene ether) resin includes poly(arylene ether) homo-polymers, poly(arylene ether) copolymers and/or poly (arylene ether) ionomers. Herein, there is no limitation of the type of the copolymer, for example block copolymer, graft copolymer, random copolymer or alternating copolymer. In the invention, the poly(arylene ether) copolymer is the copolymer in which at least one kind of structural unit is arylene ether.

The poly(arylene ether) in the invention refers to the polymer with the structural unit of the Formula (II):

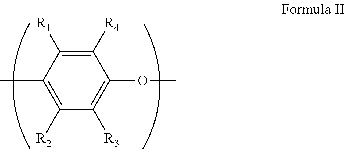

wherein for each structural unit, R₁ to R₄ are each independently hydrogen, halogen, alkyl, phenyl, alkyl phenyl, phenol, alkyl phenol, haloalkyl or aminoalkyl; herein the alkyl contains 1-8 carbon atoms.

The preferred examples of poly(arylene ether) is poly(p-phenylene oxide), poly (2,6-dimethyl-1,4-phenylene ether), poly (2-methyl-6-ethyl-1, 4-phenylene ether), poly (2-methyl-6-phenyl-1,4-phenylene ether, poly (2,3,6-trimethyl-1,4-phenylene ether), poly (2,6-dichloro-1,4-phenylene ether), poly(2,6-dimethylphenol-1,4-phenylene ether), and/or poly (2,3,6-trimethylphenol-1, 4-phenylene ether).

In the preferred embodiment of the invention, the modified poly(arylene ether) resin is α,/β-unsaturated dicarboxylic acid grafted poly(arylene ether). The α, β-unsaturated dicarboxylic compound is preferable maleic acid, fumaric acid or maleic anhydride.

In the preferred embodiment of the invention, the modified poly(arylene ether) resin in the invention is preferable maleic anhydride grafted poly(arylene ether), wherein the poly(arylene ether) is preferable poly(p-phenylene oxide), poly (2,6-dimethyl-1,4-phenylene ether), poly (2-methyl-6-ethyl-1, 4-phenylene ether), poly (2-methyl-6-phenyl-1,4-phenylene ether, and/or poly (2,3,6-trimethyl-1,4-phenylene ether). The content of maleic anhydride segment in the maleic anhydride grafted poly(arylene ether) is preferable 0.5-1 wt %. The maleic anhydride segments in the maleic anhydride grafted poly(arylene ether) could be in the any position of the poly(arylene ether) chain, such as the end position, the side chains, or be the blocks linked to the poly(arylene ether) blocks. The melting temperature of the maleic anhydride grafted poly(arylene ether) is preferably from 240° C. to 300° C. The thermal decomposition temperature of the maleic anhydride grafted poly(arylene ether) is preferable 300° C. or more. The average molecular weight of the α, β-unsaturated dicarboxylic compound grafted poly(arylene ether) is preferably 5000 to 100,000, more preferably is 10,000 to 80,000, further more preferably is 20,000 to 60,000, most preferably is 30,000 to 50,000.

The modified poly(arylene ether) resin in the present invention is preferably in the amount of 7-19 wt %, more preferably is of 10-15 wt %, most preferably is of 12-14 wt %, wt % is based on the total weight of the thermoplastic polyamide composition.

The D glass fiber is the conventional D-level glass fiber, the main components of D glass fiber is 72-75 wt % silica, up to 23 wt % boron oxide, up to 4 wt % Na₂O and K₂O. D glass fiber could also comprise small amount of Al₂O₃, Li₂O and CaO. The D glass fiber was disclosed in “Handbook of Fillers and Reinforcements for Plastics”, published by VAN NOSTRAND REINFOLD COMPANY, Page 480 and 481.

The D glass fiber in the present invention is preferably in the amount of 35-60 wt %, more preferably is 40-55 wt %, most preferably is 45-50 wt %, wt % is based on the total weight of the thermoplastic polyamide composition.

The composition could also comprise various conventional additives so long as the additives not significantly adversely affect the desired properties of the composition in the invention. The additives could include lubricant, surface effect additive, antioxidant, colorant, heat stabilizer, light stabilizer, flow modifier, plasticizer, demolding agent, flame retardant, anti-drip agent, radiation stabilizer, ultraviolet absorbing, ultraviolet light stabilizer, release agent, antimicrobial agent and/or filler.

The lubricant could be the conventional lubricant, such as ethylene bis stearamide (EBS), fatty acid ester, wax, phthalic acid ester and/or silicones.

The light stabilizer could be the conventional light stabilizer, such as hindered amine compounds, benzophenone, benzotriazole and/or salicylates light stabilizer. The preferred light stabilizer could be 2-hydroxy-4-n-octoxy benzophenone, 2-(2-hydroxy-5-methylphenyl) benzotriazole, aryl salicylates, and/or 2-(2-hydroxy-5-tert-octylphenyl) benzotriazole, etc.

The flame retardant could be the conventional flame retardant, for example the inorganic flame retardant and/or organic flame retardant. The organic flame retardant could include phosphorus, sulfur based, brominated, chlorinated and/or nitrogen flame retardant.

The filler could be the conventional filler, for example mica, clay, calcium carbonate, gypsum, calcium silicates, kaolin, calcined kaolin, potassium titanate, wollastonite, aluminum silicate, talc, and/or chalk.

The content of the additives in the composition is 5 wt % or less, preferably is 3 wt % or less, more preferably is 2 wt % or less.

In a preferred embodiment, the thermoplastic polyamide composition comprises the long chain polyamide of 20-50 wt %, maleic anhydride grafted poly(arylene ether) of 5-20 wt %, D glass fiber of 40-55 wt %, and 0-5 wt % of additives, wt % is based on the total weight of the thermoplastic polyamide composition. The additives are preferably antioxidant and/or lubricant. The long chain polyamide is preferably the polyamide from diacid and diamine with 10 or more carbon atoms in either diacid or diamine monomer.

The present invention also discloses a manufacturing method of the thermoplastic polyamide composition, comprising combining all the components of the thermoplastic polyamide composition.

In a preferred embodiment, the combining could be extruding or melt kneading. Preferred extrusion process is all the components except for the D glass fiber are pre-mixed then fed into main throat, D glass fiber is fed at a down-stream throat into screw extruder.

The present invention also discloses an application of the thermoplastic polyamide composition in high frequency communication products, especially in antenna housing, mobile device or integrated circuit.

In the present invention, all the technical features mentioned above could be freely combined to form the preferred embodiments.

The present invention has the following benefits: the dielectric property of the thermoplastic polyamide composition is quite low which has advantage in high frequency communication. The mechanical properties of the polyamide composition don't decrease and still in a good level for the application.

### Embodiments

The following examples serve to illustrate the invention, but they are not intended to limit it thereto:

The components used in the embodiments are:

PA12.12: Relative viscosity is 2.2-2.5 measured in sulfuric acid solution of 98 wt % at 25° C., Tₘ=180° C.;

PA10.10: Relative viscosity is 2.2-2.5 measured in sulfuric acid solution of 98 wt % at 25° C., Tₘ=205° C.;

AO1098: antioxidant, BNX 1098 from Mayzo Inc;

PPO-g-MAH: Fine-Blend™ CMG-W-01 from Nantong Sunny Polymer New Materials Technology Co., Ltd; wherein PPO is poly(oxy(2,6-dimethyl-1,4-phenylene)), MAH is maleic anhydride, ratio of MAH to PPO-g-MAH is 0.5-1 wt %;

D glass fiber: ECS301 HP-3-K/HL from Chongqing Polycomp. International Corporation; EBS: N,N′-Ethylenedi(stearamide) from Croda Trading (Shanghai) Co., Ltd.

The extruding condition for the following examples are:

The zone temperature of the screw extruder is: zone 1 at 25° C., zone 2 at 250° C., zone 3 at 270° C., zone 4 at 280° C., zone 5 at 280° C., zone 6 at 285° C., zone 7 at 290° C., zone 8 at 290° C., zone 9 at 295° C.; the screw speed is 350 rpm; the die temperature is 300° C., the size of the die is 4 mm; the throughput is 30 kg/h.

### Examples 1-6

All the components of the example composition are listed in Table 1. All the components except for glass fiber were pre-blended and fed into throat, and then extruded using a twin-screw extruder. Glass fiber were fed at down-stream (zone 7) to keep good shape retention. The extrudate was cooled through a water bath prior to pelletizing, obtained pellets.

TABLE 1

| | Unit | E1 | E2 | E3 | E4 | E5 | E6 |
|---|---|---|---|---|---|---|---|
| PA12.12 | % | 37 | 30 | 25 | 35 | — | 45 |
| PA10.10 | % | — | — | — | — | 30 | — |
| AO1098 | % | 0.3 | 0.3 | 0.3 | 0.3 | 0.3 | 0.3 |
| EBS | % | 0.7 | 0.7 | 0.7 | 0.7 | 0.7 | 0.7 |
| PPO-g-MAH | % | 7 | 14 | 19 | 14 | 14 | 14 |
| D glass fiber | % | 55 | 55 | 55 | 50 | 55 | 40 |
| MVR | cm³/10 min | 14.6 | 11.3 | 8.7 | 12.7 | 20.3 | 29.1 |
| TM | MPa | 14200 | 14400 | 14400 | 12600 | 15100 | 11500 |
| TS at break | MPa | 195 | 199 | 175 | 176 | 203 | 179 |
| TE at break | % | 3 | 3.1 | 2.2 | 3 | 2.6 | 3.7 |
| FM | MPa | 13100 | 14100 | 14000 | 12400 | 14300 | 10700 |
| FS | MPa | 314 | 312 | 259 | 282 | 303 | 277 |
| Charpy notched | kJ/m² | 21 | 20 | 14 | 22 | 19 | 25 |
| Charpy unnotched | kJ/m² | 98 | 98 | 65 | 95 | 89 | 113 |
| HDT | ° C. | 172 | 180 | 181 | 181 | 181 | 179 |
| Water absorption | % | 0.32 | 0.29 | 0.27 | 0.3 | 0.29 | 0.39 |
| Warpage rating | — | Medium | Good | Good | Good | Good | Good |
| D_{K} (2.5 GHz) | | 3.3 | 3.2 | 3.2 | 3.2 | 3.3 | 3.2 |
| D_{F} (2.5 GHz) | | 0.007 | 0.009 | 0.007 | 0.008 | 0.008 | 0.009 |

### Comparative Examples 1-5

All the components of the comparative composition are listed in Table 2. All the components except for glass fiber were pre-blended and fed into throat, and then extruded using a twin-screw extruder. Glass fiber were fed at down-stream (zone 7) to keep good shape retention. The extrudate was cooled through a water bath prior to pelletizing, obtained pellets.

TABLE 2

| | Unit | C1 | C2 | C3 | C4 | C5 |
|---|---|---|---|---|---|---|
| PA12.12 | % | 44 | 20 | 15 | 30 | — |
| PA66 | % | — | — | — | — | 30 |
| AO1098 | % | 0.3 | 0.3 | 0.3 | 0.3 | 0.3 |
| EBS | % | 0.7 | 0.7 | 0.7 | 0.7 | 0.7 |
| PPO-g-MAH | % | — | 24 | 29 | 14 | 14 |
| D glass fiber | % | 55 | 55 | 55 | — | 55 |
| E glass fiber | % | — | — | — | 55 | — |
| MVR | cm³/10 min | 15.5 | 4.9 | 3.7 | 14.2 | 18.7 |
| TM | MPa | 13800 | 14900 | 14900 | 15600 | 17700 |
| TS at break | MPa | 172 | 167 | 167 | 184 | 236 |
| TE at break | % | 3.5 | 1.9 | 1.7 | 3.1 | 2.4 |
| FM | MPa | 12700 | 14700 | 14400 | 14900 | 16200 |
| FS | MPa | 278 | 257 | 243 | 300 | 357 |
| Charpy notched | kJ/m² | 25 | 12 | 11 | 21 | 22 |
| Charpy unnotched | kJ/m² | 99 | 53 | 42 | 94 | 87 |
| HDT | ° C. | 165 | 182 | 183 | 179 | 246 |
| Water absorption | % | 0.28 | 0.3 | 0.3 | 0.28 | 0.81 |
| Warpage rating | — | Poor | Good | Good | Good | Poor |
| DK (2.5 GHz) | | 3.4 | 3.2 | 3.2 | 3.6 | 3.5 |
| DF (2.5 GHz) | | 0.01 | 0.006 | 0.006 | 0.008 | 0.008 |

Test: after drying the obtained pellets at 90° C. for 8 hours, all the testing specimens were prepared from the pellets using a 130 T injection molding machine at a melt temperature 300° C. and at mold temperature 80° C. The samples were tested for various mechanical properties using the standard ISO method. The test results of examples 1-6 and comparative examples 1-5 are listed in Table 1 and 2.

MVR: melt volume-flow rate was tested according to ISO1133-2011, the test condition is 2.16

Kg load at 325° C.

TM (tensile modulus), TS at break (tensile stress at break), TE at break(tensile strain at break): was tested according to ISO 527-2-2012 at 23° C.

FM (flexural modulus), FS (flexural strength) was tested according to ISO 178-2010 at 23° C. Charpy notched impact strength and Charpy unnotched impact strength was tested according to ISO 179-1-2010 at 23° C., the sample stripe is 80*10*4 mm.

HDT (temperature of deflection under load) was tested according to ISO 75-2-2013 using a flexural stress of 1.80 MPa.

Water absorption was tested according to ISO 62-2008 after immersing in the water of 23° C. for 24 hours.

The warpage performance was evaluated by visual check of a 0.75 mm round disk molded at same condition and rated with three ratings: good, medium and poor.

The dielectric performance (D_{K} and D_{F}) was evaluated using a 60 mm×60 mm×2 mm injection molded color plaque by strip-line resonator method (GB/T 12636-90) with Agilent E8363C machine.

It could be seen from Table 1 and 2:
C1 and E6 shows that modified PPO could help to decrease the dielectric property of the thermoplastic composition and obviously improve the warpage performance.
Comparing E5 with C5, the only difference is the type of polyamide (PA10.10 VS PA66), when the short chain polyamide is used, the warpage performance of thermoplastic polyamide composition is poor, the water absorption increases a lot, and D_{K} of C5 is 0.2 higher than E5.
Comparing E3 with C2 or C3, the amount of modified PPO is 19 wt %, 24 wt % and 29 wt %, when the amount of modified PPO is higher than 20 wt %, the mechanical properties of the thermoplastic composition decreases rapidly, especially the MVR, TS at break, TE at break and Charpy.

Based on the above comparative examples, the present invention could decrease the dielectric properties and keep the mechanical properties in a good level to fit with the requirement of high frequency communication technology.

1. A thermoplastic polyamide composition comprising long chain polyamide of 25-65 wt %, modified poly(arylene ether) resin of 5-20 wt %, and D-glass fibers of 30-65 wt % based on the weight of the thermoplastic polyamide composition.

2. The thermoplastic polyamide composition according to claim 1, wherein the long chain polyamide is a long chain polyamide from lactam which has 8 or more carbon atoms, or a long chain polyamide from diacid and diamine in which at least one of diacid and diamine has 8 or more carbon atoms.

3. The thermoplastic polyamide composition according to claim 1, wherein the long chain polyamide from lactam has from 8 to 14 carbon atoms; the diacid of the long chain polyamide from diacid and diamine is alkane dicarboxylic acid of from 6 to 24 carbon atoms; and the diamine of the long chain polyamide from diacid and diamine is alkane diamine of from 6 to 24 carbon atoms.

4. The thermoplastic polyamide composition according to claim 1, wherein the long chain polyamide is at least one selected from the group consisting of PA8, PA9, PA10, PA11, PA12, PA13, PA4.8, PA4.10, PA4.12, PA4.14, PA4.18, PA5.8, PA5.10, PA5.12, PA5.14, PA5.18, PA6.8, PA6.10, PA6.12, PA6.14, PA6.18, PA8.8, PA8.10, PA8.12, PA10.10, PA10.12, PA10.14, PA10.18, PA12.10, PA12.12, PA12.14, PA12.18, PA14.10, PA14.12, PA 14.14, PA14.18, PA8.T, PA9.T, PA10.T, PA12.T, PA8.I, PA9.I, PA10.I, and PA12.I.

5. The thermoplastic polyamide composition according to claim 1, wherein the relative viscosity of the long chain polyamide is 1.8-4.0 measured in sulfuric acid solution of 98 wt % at 25° C.

6. The thermoplastic polyamide composition according to claim 1, wherein the long chain polyamide is in the amount of 30-60 wt % based on the total weight of the thermoplastic polyamide composition.

7. The thermoplastic polyamide composition according to claim 1, wherein the modified poly(arylene ether) resin is α, β-unsaturated dicarboxylic acid grafted poly (arylene ether) and/or anhydride of α, β-unsaturated dicarboxylic acid grafted poly (arylene ether).

8. The thermoplastic polyamide composition according to claim 7, wherein the α, β-unsaturated dicarboxylic acid is at least one selected from the group consisting of maleic acid, fumaric acid, itaconic acid, tetrahydrophthalic acid, and citraconic acid; and the anhydride of α, β-unsaturated dicarboxylic acid is at least one selected from the group consisting of maleic anhydride, itaconic anhydride, gluconic anhydride, citraconic anhydride and tetrahydrophthalic anhydride.

9. The thermoplastic polyamide composition according to claim 7, wherein the poly(arylene ether) having the structural unit of the Formula (II): 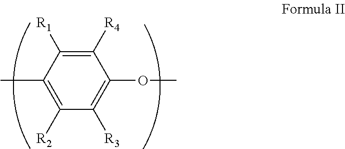
wherein for each structural unit, R₁ to R₄ are each independently hydrogen, halogen, alkyl, phenyl, alkyl phenyl, phenol, alkyl phenol, haloalkyl or aminoalkyl; wherein the alkyl contains 1-8 carbon atoms.

10. The thermoplastic polyamide composition according to claim 9, wherein the poly(arylene ether) is poly(p-phenylene oxide), poly (2,6-dimethyl-1,4-phenylene ether), poly (2-methyl-6-ethyl-1, 4-phenylene ether), poly (2-methyl-6-phenyl-1,4-phenylene ether, poly (2,3,6-trimethyl-1,4-phenylene ether), poly (2,6-dichloro-1,4-phenylene ether), poly(2,6-dimethylphenol-1,4-phenylene ether), or poly (2,3,6-trimethylphenol-1, 4-phenylene ether).

11. The thermoplastic polyamide composition according to claim 7, wherein the modified poly(arylene ether) resin is maleic anhydride grafted poly(arylene ether).

12. The thermoplastic polyamide composition according to claim 7, wherein the modified poly(arylene ether) resin is in the amount of 7-19 wt % based on the total weight of the thermoplastic polyamide composition.

13. The thermoplastic polyamide composition according to claim 1, wherein the D glass is in the amount of 35-60 wt % based on the total weight of the thermoplastic polyamide composition.

14. The thermoplastic polyamide composition according to claim 1, wherein the composition also comprises additives.

15. The thermoplastic polyamide composition according to claim 1, wherein the lubricant is ethylene bis stearamide, fatty acid ester, wax, phthalic acid ester and/or silicones; the light stabilizer is hindered amine compounds, benzophenone, benzotriazole and/or salicylates light stabilizer; the flame retardant is phosphorus, sulfur based, brominated, chlorinated and/or nitrogen flame retardant; and the filler is mica, clay, calcium carbonate, gypsum, calcium silicates, kaolin, calcined kaolin, potassium titanate, wollastonite, aluminium silicate, talc and/or chalk.

16. A manufacturing method of the thermoplastic polyamide composition according to claim 1, comprising combining all components of the thermoplastic polyamide composition.

17. The manufacturing method according to claim 16, wherein the combining comprising the following steps: all the components of the thermoplastic polyamide composition except for the D glass fiber being pre-mixed then fed into main throat and D glass fiber being fed at a down-stream throat into screw extruder.

18. A method of using the thermoplastic polyamide composition according to claim 1, the method comprising using the thermoplastic polyamide composition in a high frequency communication product.

19. The method of claim 18, wherein the high frequency communication product is an antenna housing, a mobile device, or an integrated circuit.

20. The thermoplastic polyamide composition according to claim 2, wherein the long chain polyamide from lactam is polyamide 8, 9, 10, 11, 12 or 13; the diacid of the long chain polyamide from diacid and diamine is of from 6 to 18 carbon atoms and/or the aromatic diacid; and the diamine of the long chain polyamide from diacid and diamine is from 6 to 18 and/or the aromatic diamine.
